(19) United States
(12) Patent Application Publication
(10) Pub. No.: US 2010/0148990 A1
(43) Pub. Date: Jun. 17, 2010

(54) SYSTEM AND METHOD FOR SELECTIVELY DISPLAYING TERMINAL PROCEDURE DATA

(75) Inventors: Roger W. Burgin, Scottsdale, AZ (US); Blake Wilson, Peoria, AZ (US); Dave Pepitone, Sun City West, AZ (US)

Correspondence Address: HONEYWELL/IFL;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/337,092

(22) Filed: Dec. 17, 2008

(51) Int. Cl. G01C 21/00

(52) U.S. Cl. 340/971

(57) ABSTRACT

A flight deck display system is provided for selectively displaying terminal procedure data. The flight deck display system comprises at least one display device, a terminal procedure data source, and a processor coupled to the at least one display device and the terminal procedure data source. The processor is configured to selectively retrieve the terminal procedure data from the terminal procedure data source based on at least one terminal procedure parameter and display the retrieved terminal procedure data on the at least one display device.

### TECHNICAL FIELD

The present invention relates to a vehicle display system and method and, more particularly, to a system and method for selectively displaying terminal procedure data.

### BACKGROUND

Aircraft egress from, and aircraft ingress to, airports is conducted in accordance with predetermined terminal procedures. As is generally known, the terminal procedures for each airport generally include one or more arrival procedures and one or more departure procedures. Arrival procedures are used to move an aircraft from its en route airspace to a terminal airspace for landing. Departure procedures are used to move an aircraft from a terminal airspace to en route airspace. Arrival procedures and departure procedures are typically characterized by one or more terminal procedure parameters. For example, a departure procedure may be characterized by a departure runway and a departure transition. Further, an arrival procedure may be characterized an arrival transition. Each terminal procedure also includes various types of information such as communication frequencies, course headings, navigational aids, and minimum altitudes.

The terminal procedures are published as charts, using textual, graphical, and iconic formats, by governments and, in some instances, by various companies. For example, in the United States (U.S.), Jeppesen publishes terminal procedures. The terminal procedures are typically published as printed paper books. The terminal procedures covering airports in the U.S., Puerto Rico, Virgin Islands, and Pacific Territories, are published by the U.S. government as a 26 volume set of printed books known as the U.S. Terminal Procedures Publication (TPP). The TPP provides various types of arrival and departure procedures for each airport in this coverage area, including Departure Procedure (DP) charts and Standard Terminal Arrival (STAR) charts.

These published DP charts and STAR charts, or portions thereof, are provided onboard each aircraft for use by the flight crews. Alternatively, electronic versions of the DP charts or STAR charts may be displayed on an electronic display device. Established rules and regulations mandate that the terminal procedures are in view of the aircraft flight crew when conducting an arrival procedure or departure procedure. Thus, before conducting one of these procedures the flight crew retrieves the appropriate terminal procedure chart (e.g., the electronic and/or paper version) to extract the appropriate terminal procedure data.

However, each DP chart or STAR chart may include terminal procedure data describing a plurality of terminal procedures. For example, a DP chart may include terminal procedure data describing departure procedures that correspond to multiple departure runways and transitions. Further, a STAR chart may include terminal procedure data describing arrival procedures that correspond to multiple arrival transitions. Thus, in order to extract information relevant to a desired terminal procedure the flight crew is required to analyze the entire terminal procedure publication chart. This process requires the flight crew to review information that is not relevant to the desired terminal procedure and results in an unnecessary increase in the workload of the aircraft flight crew.

Accordingly, it is desirable to provide a system and method for selectively displaying terminal procedure data corresponding to a desired departure procedure or arrival procedure. Furthermore, other desirable features and characteristics of the present invention will become apparent from the subsequent detailed description of the invention and the appended claims, taken in conjunction with the accompanying drawings and this background of the invention.

### BRIEF SUMMARY

In one embodiment a flight deck display system is provided for selectively displaying terminal procedure data. The flight deck display system comprises at least one display device, a terminal procedure data source, and a processor coupled to the at least one display device and the terminal procedure data source. The processor is configured to selectively retrieve the terminal procedure data from the terminal procedure data source based on at least one terminal procedure parameter and display the retrieved terminal procedure data on the at least one display device.

### BRIEF DESCRIPTION OF THE DRAWINGS

The present invention will hereinafter be described in conjunction with the appended drawing figures, wherein like numerals denote like elements, and in which:

FIG. 1 depicts an exemplary Departure Procedure chart published by the U.S. Government;

FIG. 2 is a table representing an exemplary Departure Procedure database;

FIG. 3 depicts an exemplary Standard Terminal Arrival Route chart published by the U.S. Government;

FIG. 4 depicts and exemplary Standard Terminal Arrival Route database;

FIG. 5 is a functional block diagram of a flight deck display system according to one embodiment of the present invention;

FIG. 6 is a simplified representation of an exemplary primary flight display (PFD) display screen that may be used in the system of FIG. 5,

FIG. 7 is a simplified representation of an exemplary multi-function display (MFD) display screen that may be used in the system of FIG. 5;

FIG. 8 depicts an exemplary selectable menu for selecting a departure runway and a departure transition; and

FIG. 9 depicts an exemplary user display window for displaying selected terminal procedure data and iconic data.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description. In this regard, the present invention may be described in terms of functional block diagrams and various processing steps. It should be appreciated that such functional blocks may be realized in many different forms of hardware, firmware, and/or software components configured to perform the various functions. For example, the present invention may employ various integrated circuit components, e.g., memory elements, digital signal processing elements, look-up tables, and the like, which may carry out a variety of functions under the control of one or more microprocessors or other control devices. Such general techniques are known to those skilled in the art and are not described in detail herein. Furthermore, the various methods presented in the drawing Figures or the specification are not to be construed as limiting the order in which the individual processing steps may be performed. It should be appreciated that the particular implementations shown and described herein are illustrative of the invention and its best mode and are not intended to otherwise limit the scope of the invention in any way.

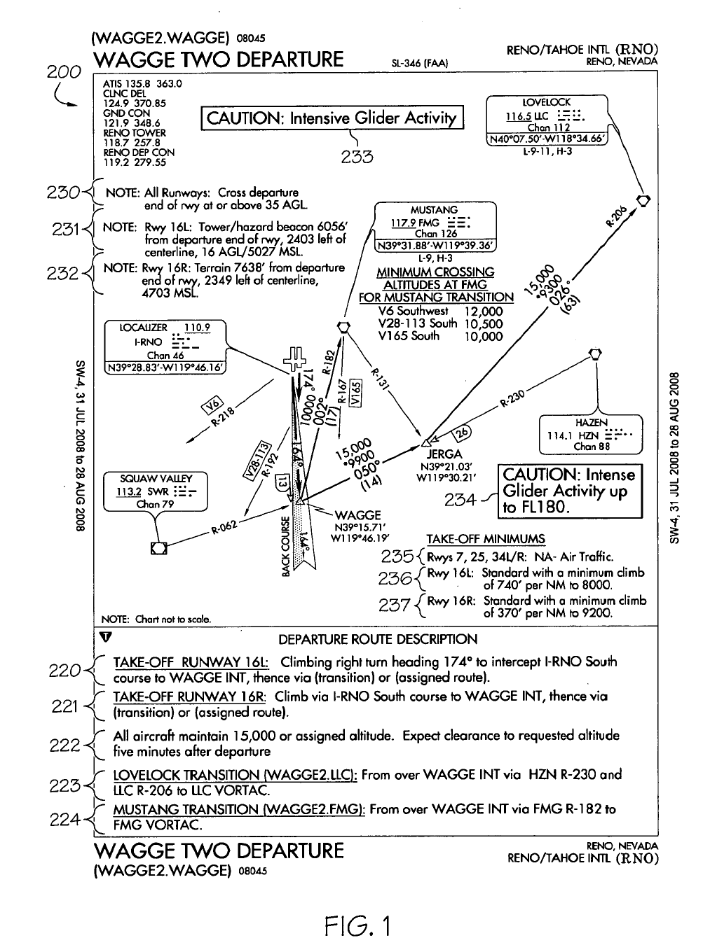

FIG. 1 depicts an exemplary Departure Procedure (DP) chart 200 published by the U.S. Government. Each DP chart describes one or more departure procedures or Standard Instrument Departures (SIDs) from a departure airport. DP chart 200 describes the Wagge Two Departure (WAGGE2.WAGGE) from the Reno-Tahoe International Airport (RNO) in Reno Nev. As described above, a departure procedure is typically characterized by two terminal procedure parameters, a departure runway and a departure transition from terminal airspace to en route airspace. DP chart 200 describes two departure runways, Runway 16L (referred to as RWY 16L) and Runway 16R (referred to as RWY 16R). In addition, two possible departure transitions are described, the Lovelock Transition (WAGGE2.LLC) and the Mustang Transition (WAGGE2.FMG). Thus, there are four possible departure procedures (e.g., corresponding to the four different combinations of departure runways and transitions) described in DP chart 200.

DP chart 200 includes textual and graphical information for the Wagge Two Departure, including communication data (e.g., communication frequencies), lateral fix data (e.g., headings, indents, radials, etc.), vertical fix data (altitudes, angles), missed approach data, various minimum data (e.g., minimum airspeeds, minimum altitudes, etc.), and aircraft performance data (e.g., climb gradients, landing distances, etc.). In addition, DP chart 200 includes textual departure procedure descriptions and departure procedure notes. The departure procedure descriptions 220, 221, 222, 223, and 224 each provide a narrative describing one or more steps for a departure procedure. The departure procedure notes 230, 231, 232, 233, 234, 235, 236, and 237 describe hazards, minimum altitudes, alerts, and provide other relevant information that does not appear in the “Departure Route Description” section of DP chart 200.

Certain of the departure procedure descriptions 220-224 and departure procedure notes 230-237 for DP chart 200 correspond to specific terminal procedure parameters for the Wagge Two Departure. For example, departure procedure notes 231 and 236, and departure procedure description 220 each correspond to Runway 16L. Further, departure procedure description 223 corresponds to the Livelock Transition. Alternatively, certain of the departure procedure descriptions 220-224 and departure procedure notes 230-237 include general information that is relevant to all of the departure procedures for the Wagge Two Departure. Departure procedure notes 230, 233, and 234, and departure procedure description 222, each include such general information.

Thus, to extract information regarding a specific departure procedure or SID the flight crew must analyze DP chart 200 to extract only the information that is relevant to the appropriate departure procedure parameters. As described above, this requires the flight crew to analyze all of the information on DP Chart 200, even the entries that do not correspond to the appropriate runway and transition, increasing the workload for the flight crew. Embodiments described below provide a Departure Procedure (DP) database that associates departure procedure descriptions and notes with their corresponding airport departure and terminal parameters. As further described below, the DP database enables the flight crew to selectively retrieve the departure procedure descriptions and notes that correspond to the parameters for a desired departure procedure.

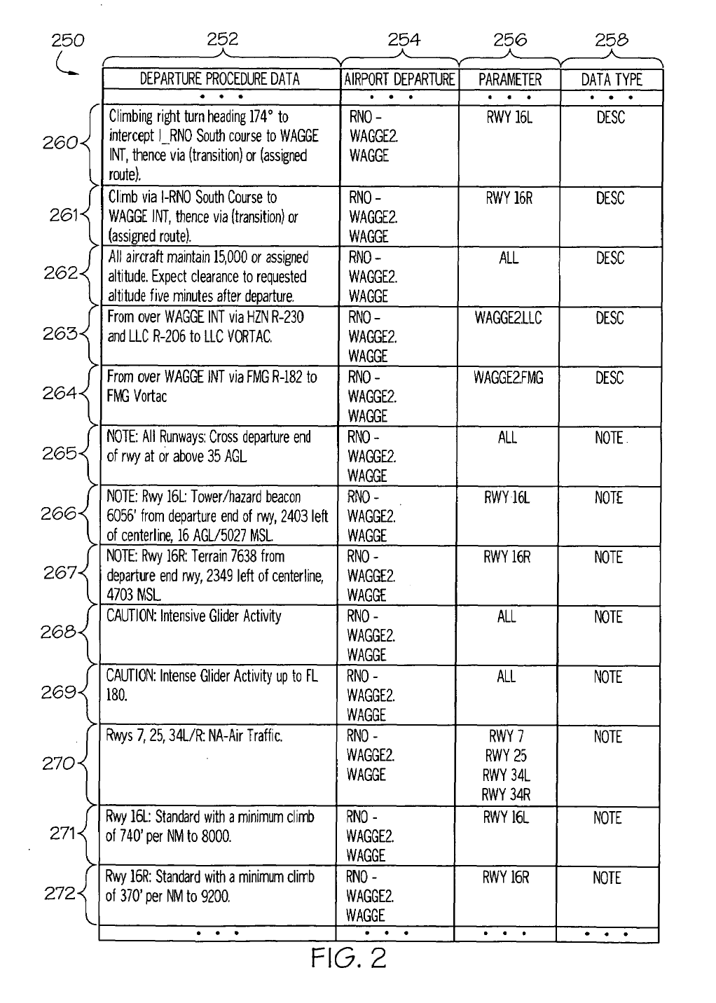

FIG. 2 is a table depicting an exemplary DP database 250. In the depicted embodiment, each record in the DP database 250 includes a departure procedure data field 252, an airport departure field 254, a parameter field 256, and a data type field 258. The departure procedure data field 252 stores descriptive text that corresponds to a departure procedure. The descriptive text may comprise departure procedure descriptions and departure procedure notes that are extracted from a DP chart of the type described above with regard to FIG. 1. The airport departure field 254 identifies the airport departure for the corresponding departure procedure. The parameter field 256 identifies a terminal procedure parameter (e.g., a departure runway or a departure transition) associated with the descriptive text or indicates that the descriptive text comprises general information relevant to all of the departure procedures for the corresponding airport departure. Finally, the data type field 258 indicates whether the corresponding descriptive text comprises a departure procedure description or a departure procedure note. It should be noted that other embodiments may utilize alternative database configurations, so long as such database configurations associate departure procedure data with one or more corresponding departure procedure parameters.

With reference to FIGS. 1 and 2, and as described above, the departure procedure data field 252 may comprise departure procedure descriptions and departure procedure notes that are extracted from a plurality of DP charts. For example, the departure procedure descriptions and notes depicted in DP chart 200 are stored within the departure procedure data field 252 of DP database 250. As depicted, rows 260, 261, 262, 263, and 264 of DP database 250 correspond, respectively, to departure procedure descriptions 220-224 of DP chart 200. Further, rows 265, 266, 267, 268, 269, 270, 271, and 272 of DP database 250 correspond, respectively, to departure procedure notes 230-237 of DP chart 200. Although the depicted DP database 250 includes information extracted only from DP chart 200 it should be understood that other embodiment of the DP database may comprise departure procedure data extracted from a large number of DP charts.

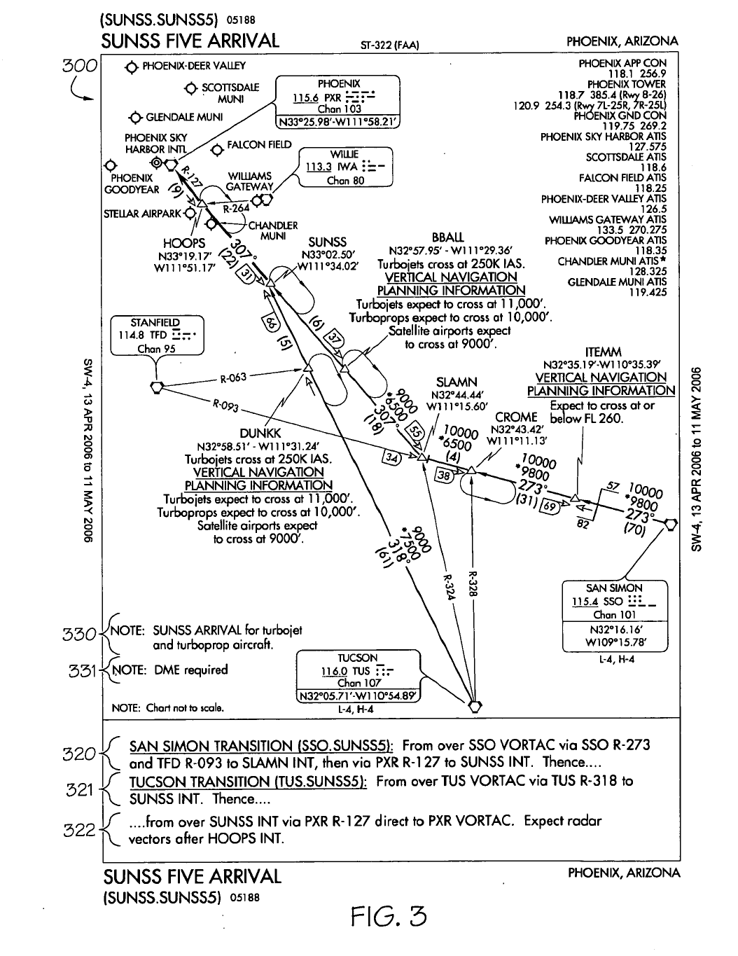

FIG. 3 is a depiction of an exemplary Standard Terminal Arrival Route (STAR) chart 300. Each STAR chart is published by the U.S. Government and describes one or more arrival route procedures or Standard Terminal Arrival Routes (STARs) for an airport arrival. STAR chart 300 describes the Sunss Five Arrival (SUNSS.SUNSS5) for Sky Harbor International Airport (PHX) in Phoenix, Ariz. As described above, each arrival procedure is associated with a terminal procedure parameter that comprises an arrival transition from en route airspace to terminal airspace. STAR chart 300 describes two arrival transitions, the San Simon Transition (SSO.SUNSS5) and the Tucson Transition (TUS.SUNSS5). Thus, there are two arrival procedures or STARS (e.g., corresponding to the two different arrival transitions) described in STAR chart 300.

STAR chart 300 includes information that is similar to that described above with respect to DP chart 200 (FIG. 1). In addition, STAR chart 300 also includes textual arrival procedure descriptions and arrival procedure notes. The arrival procedure descriptions 320, 321, and 322 provide narratives describing the steps for a corresponding arrival procedure and the arrival procedure notes 330, 331 provide additional information regarding the arrival procedure.

As with the departure procedure descriptions and notes for DP chart 200 (FIG. 1), certain of the arrival procedure descriptions 320-322 and/or arrival procedure notes 330, 331 of STAR chart 300 correspond to a specific terminal procedure parameter (e.g., arrival transition), while others include general information that is relevant to all of the arrival procedure parameter. Thus, to extract information regarding an arrival procedure from STAR chart 300 the flight crew must analyze the entire chart resulting in an increased workload. Embodiments described below provide a Standard Terminal Arrival Route (STAR) database that associates arrival procedure descriptions and notes with their corresponding airport arrival and terminal parameters. As further described below, the STAR database enables the flight crew to selectively retrieve the arrival procedure descriptions and notes for a desired arrival procedure.

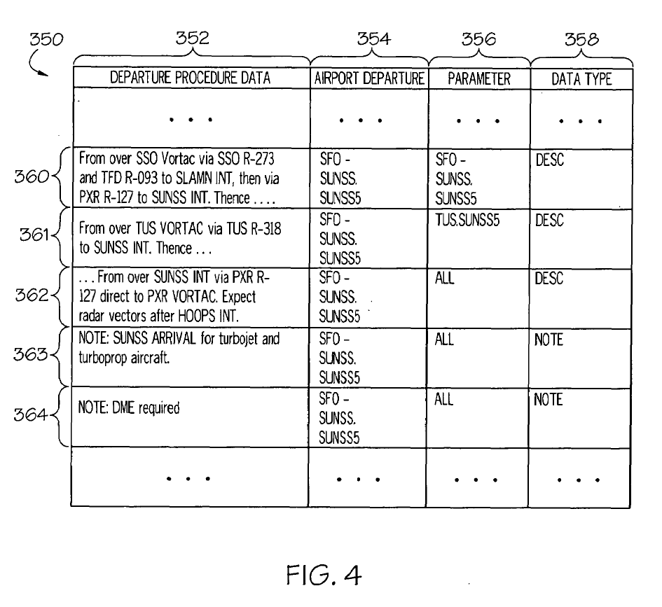

FIG. 4 is a table depicting an exemplary STAR database 350. In the depicted embodiment, each record in the STAR database 350 comprises an arrival procedure data field 352, an airport arrival field 354, a parameter field 356, and a type field 358. The arrival procedure data field 352 stores descriptive text that corresponds to an arrival procedure. The descriptive text may comprise arrival procedure descriptions or arrival procedure notes that are extracted from a STAR chart of the type described above with regard to FIG. 3. The airport arrival field 354 identifies an airport arrival for the corresponding arrival procedure data. The parameter field 356 identifies a terminal procedure parameter (e.g., an arrival transition) associated with the arrival procedure data or indicates that the arrival procedure data comprises general information that is relevant to all of the arrival procedure parameters. The data type field 358 indicates whether the corresponding arrival procedure data comprises an arrival procedure description or an arrival procedure note. It should be noted that other embodiments may utilize alternative database configurations, so long as such database configurations associate arrival procedure data with one or more corresponding arrival procedure parameters. For example, in one embodiment the DP database 250 described above with regard to FIG. 2 and the STAR database 350 may comprise a single database that storing terminal procedure data describing departure procedures and arrival procedures.

With reference to FIGS. 3 and 4, and as described above, the arrival procedure data field 352 may comprise arrival procedure description and notes extracted from a plurality of STAR charts. For example, the arrival procedure descriptions and notes depicted in STAR chart 300 are stored within the arrival procedure data field 352 of STAR database 350. As depicted rows, 360, 361, and 362 of the STAR database 350 correspond to arrival procedure descriptions 320-322 of STAR chart 300. Further, rows 363 and 364 correspond to arrival procedure notes 330-331. Although the depicted STAR database 350 includes information extracted from a single STAR chart 300 it will be understood that in other embodiments, STAR database 350 will include departure procedure data compiled from a large number of STAR charts.

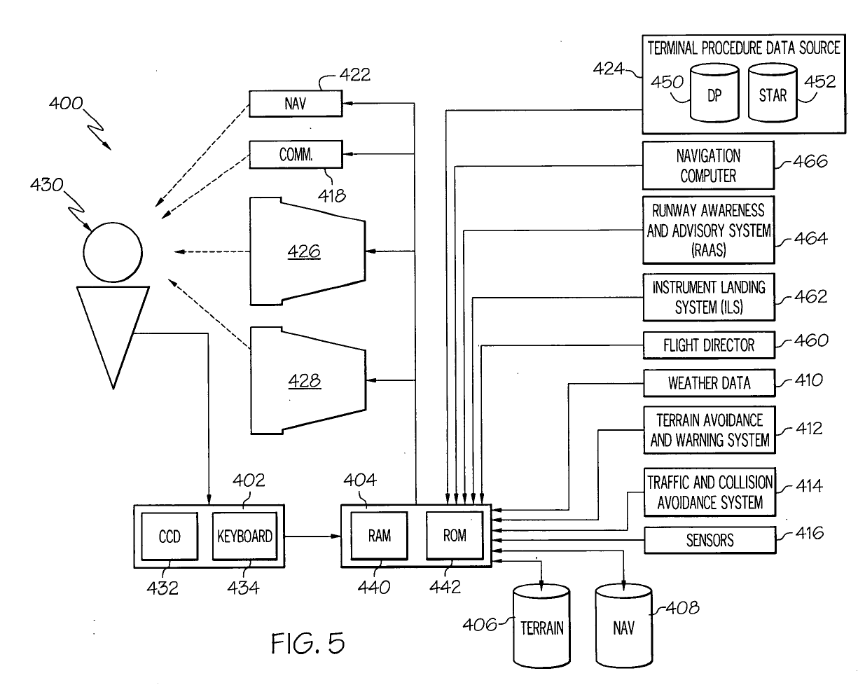

Turning now to FIG. 5, an exemplary flight deck display system 400 for use with embodiments of the present invention is described. In the depicted embodiment, the system 400 includes a user interface 402, one or more processors 404, one or more terrain databases 406, one or more navigation databases 408, a source of weather data 410, a terrain avoidance and warning system (TAWS) 412, a traffic and collision avoidance system (TCAS) 414, various sensors 416, communication radios 418, navigation radios 422, a terminal procedure data source 424, and a plurality of display devices 426, 428. Before proceeding further, it will be appreciated that the depicted system 400 is merely exemplary, and that it could be implemented without one or more of the depicted components, systems, and data sources. It will additionally be appreciated that the system 400 could be implemented with one or more additional components, systems, or data sources, or receive inputs therefrom. Indeed, as is depicted, and will be further described below, the system 400 does receive inputs from various other external systems.

Returning now to a description of the system 400, the user interface 402 is in operable communication with the processor 404 and is configured to receive input from a user 430 (e.g., a pilot or co-pilot) and, in response to the user input, supply command signals to the processor 404. The user interface 402 may be any one, or combination, of various known user interface devices including, but not limited to, a cursor control device (CCD) 432, such as a mouse, a trackball, or joystick, and/or a keyboard, one or more buttons, switches, or knobs. In the depicted embodiment, the user interface 402 includes a CCD 432 and a keyboard 434. The pilot 430 uses the CCD 432 to, among other things, move a cursor symbol on a display screen, and may use the keyboard 434 to, among other things, input textual data.

The processor 404 is in operable communication with the terrain databases 406, the navigation databases 408, the radios 418, 422, the terminal procedure data source 424, and the display devices 426, 428, and is coupled to receive various types of inertial data from the various sensors 416, and various other avionics-related data from one or more other external systems, which are briefly described further below. The processor 404 is configured, in response to the inertial data, to selectively retrieve terrain data from one or more of the terrain databases 406 and navigation data from one or more of the navigation databases 408, and to supply appropriate display commands to one or both the display devices 426, 428, so that the retrieved terrain and navigation data are appropriately displayed on one or both of the display devices 426, 428. As FIG. 5 additionally shows, the processor 404 is also in operable communication with the source of weather data 410, the TAWS 412, the TCAS 414, and is additionally configured to supply appropriate display commands to one or both of the display devices 426, 428 so that the avionics data, weather data 410, data from the TAWS 412, data from the TCAS 414, and data from the previously mentioned external systems may also be selectively displayed on one or both of the display devices 426, 428. Moreover, and as will be described further below, the processor 404 is further configured to selectively receive terminal procedure data from the terminal procedure data source 424, and to supply appropriate display commands to one or both of the display devices 426, 428 so that the terminal procedure data may be selectively displayed on or both of the display devices.

The processor 404 may be any one of numerous known general-purpose microprocessors or an application specific processor that operates in response to program instructions. In the depicted embodiment, the processor 404 includes on-board RAM (random access memory) 440, and on-board ROM (read only memory) 442. The program instructions that control the processor 404 may be stored in either or both the RAM 440 and the ROM 442. For example, the operating system software may be stored in the ROM 442, whereas various operating mode software routines and various operational parameters may be stored in the RAM 440. It will be appreciated that this is merely exemplary of one scheme for storing operating system software and software routines, and that various other storage schemes may be implemented. It will also be appreciated that the processor 404 may be implemented using various other circuits, not just a programmable processor. For example, digital logic circuits and analog signal processing circuits could also be used.

The terrain databases 406 include various types of data representative of the terrain over which the aircraft may fly, and the navigation databases 408 include various types of navigation-related data. These navigation-related data include various flight plan related data such as, for example, waypoints, distances between waypoints, headings between waypoints, data related to different airports, navigational aids, obstructions, special use airspace, political boundaries, communication frequencies, and aircraft approach information. It will be appreciated that, although the terrain databases 406 and the navigation databases 408 are, for clarity and convenience, shown as being stored separately from the processor 404, all or portions of either or both of these databases 406, 408 could be loaded into the on-board RAM 440, or integrally formed as part of the processor 404, and/or RAM 440, and/or ROM 442. The terrain databases 406 and navigation databases 408 could also be part of a device or system that is physically separate from the display system 400.

The avionics data that are supplied from the sensors 416 include data representative of the state of the aircraft such as, for example, aircraft speed, altitude, and heading. The weather data 410 supplied to the processor 404 is representative of at least the location and type of various weather cells. The data supplied from the TCAS 414 includes data representative of other aircraft in the vicinity, which may include, for example, speed, direction, altitude, and altitude trend. In a preferred embodiment, the processor 404, in response to the TCAS data, supplies appropriate display commands to one or both of the display devices 426, 428 such that a graphic representation of each aircraft in the vicinity is displayed thereon. The TAWS 412 supplies data representative of the location of terrain that may be a threat to the aircraft. The processor 404, in response to the TAWS data, preferably supplies appropriate display commands to the display devices 426 and 428 such that the potential threat terrain is displayed in various colors depending on the level of threat.

The terminal procedure data source 424 provides various forms of terminal procedure data to processor 404. For example, the terminal procedure data source 424 may provide electronic versions of procedure publication charts (e.g., DP charts and STAR charts). In addition, the terminal procedure data source 424 includes a DP database 450 and a STAR database 452. As described above, the DP database 450 associates departure procedure data (e.g., departure procedure descriptions and notes) with a corresponding airport departure and one or more terminal procedure parameters (e.g., a departure runway and departure transition). As further described below, DP database 450 enables processor 404 to selectively retrieve and display departure procedure data that is relevant to a selected airport departure, departure runway, and departure transition. Further, STAR database 452 associates arrival procedure data (e.g., arrival procedure descriptions and notes) with a corresponding arrival airport and one or more terminal procedure parameters (e.g., an arrival transition). The STAR database 452 enables processor 404 to selectively retrieve and display arrival procedure data that corresponds to a selected airport arrival and airport transition.

As was previously mentioned, one or more other external systems (or subsystems) may also provide avionics-related data to the processor 404 for display on the display devices 426, 428. In the depicted embodiment, these external systems include a flight director 460, an instrument landing system (ILS) 463, a runway awareness and advisory system (RAAS) 464, and a navigation computer 466. The flight director 460, as is generally known, supplies command data representative of commands for piloting the aircraft in response to flight crew entered data, or various inertial and avionics data received from external systems. The command data supplied by the flight director 460 may be supplied to the processor 404 and displayed on one or both of the display devices 426, 428 for use by the pilot 430, or the data may be supplied to an autopilot (not illustrated).

The ILS 462 is a radio navigation system that provides aircraft with horizontal and vertical guidance just before and during landing and, at certain fixed points, indicates the distance to the reference point of landing. The system includes ground-based transmitters (not illustrated) that transmit radio frequency signals. The ILS 463 on board the aircraft receives these signals and supplies appropriate data to the processor for display on one or both of the display devices 426, 428.

The RAAS 464 provides improved situational awareness to help lower the probability of runway incursions by providing timely aural advisories to the flight crew during taxi, takeoff, final approach, landing and rollout. The RAAS 464 uses GPS data to determine aircraft position and compares aircraft position to airport location data stored in the navigation database 408. Based on these comparisons, the RAAS 464, if necessary, issues appropriate aural advisories informing the pilot, among other things of when the aircraft is approaching a runway—either on the ground or from the air—when the aircraft has entered and is aligned with a runway, and when the runway is not long enough for the particular aircraft.

The navigation computer 466 is used, among other things, to allow the pilot 430 to program a flight plan from one destination to another. The processor 404 may receive the programmed flight plan data from the navigation computer 466 and cause the programmed flight plan, or at least portions thereof, to be displayed on one or both of the display devices 426, 428.

The display devices 426, 428 are each used to display various images and data, in a graphic, iconic, and a textual format, and to supply visual feedback to the pilot 430 in response to input commands supplied by the pilot 430 to the user interface 402. It will be appreciated that the display devices 426, 428 may each be implemented using any one of numerous known displays suitable for rendering image and/or text data in a format viewable by the pilot 430. Non-limiting examples of such displays include various cathode ray tube (CRT) displays, and various flat panel displays such as, various types of LCD (liquid crystal display) and TFT (thin film transistor) displays. The display may additionally be based on a panel mounted display, a HUD projection, or any known technology. To provide a more complete description of the method that is implemented by the flight deck display system 400, a general description of each of the display devices 426, 428 and the information each displays will now be provided below.

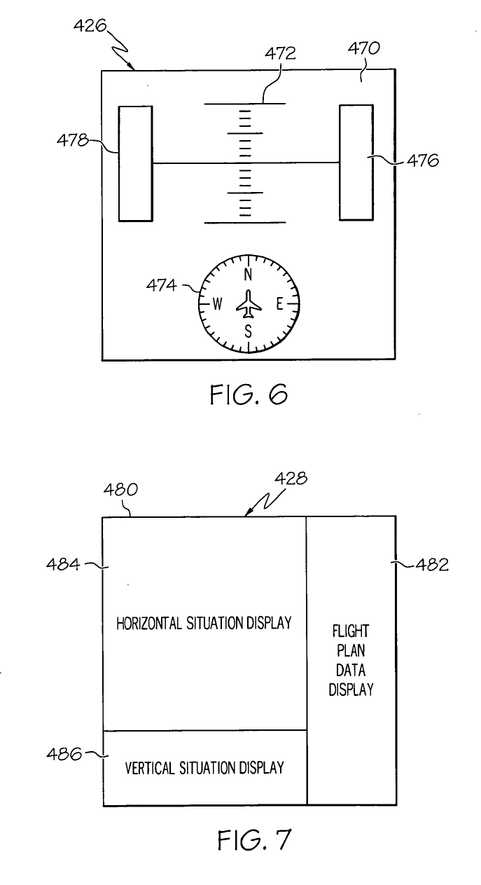

One of the display devices 426 is preferably implemented as a primary flight display (PFD), and the other display device 428 is preferably implemented as a multi-function display (MFD). The PFD 426 is used to display various types of flight information in a display area. As depicted in simplified format in FIG. 6, the flight information that is displayed in the display area 470 typically includes, for example, a combined altitude direction indicator 472, a horizontal situation indicator 474, airspeed 476, and altitude 478, just to name a few. It will be appreciated that this information may be rendered on the PFD 426 in graphic, iconic, or textual formats, or various combinations thereof.

The MFD 428 is used to display information that allows an aircraft flight crew to perform flight planning and/or aircraft system management, both before and during flight. In a particular preferred embodiment, the MFD 428 includes a display area in which multiple graphical, iconic, and/or textual images may be simultaneously displayed, preferably in different sections. For example, and as depicted in FIG. 7, the MFD 428 may display, in various sections of its display area 480, a flight-plan data display 482, a horizontal situation display 484, and a vertical situation display 486, simultaneously, alone, or in various combinations. The flight-plan data display 482 provides a textual display of various types of data related to the flight plan of the aircraft. Such data includes, but is not limited to, the flight identifier, route iteration number, a waypoint list and associated information, such as bearing and time to arrive, just to name a few. It will be appreciated that the flight-plan data display 482 may additionally display various types of data associated with various types of flight hazards.

The horizontal situation display 484 provides a two-dimensional horizontal situation view of the aircraft along the current flight path, and the vertical situation display 486 provides either a two-dimensional profile vertical situation view or a perspective vertical situation view of the aircraft along the current flight path and/or ahead of the aircraft. While not depicted in FIG. 7, the horizontal situation display 484 and the vertical situation display 486 may each selectively display various features including, for example, a top-view symbol and a side-view aircraft symbol, respectively, in addition to various symbols representative of the current flight plan, various navigation aids, and various map features below and/or ahead of the current flight path such as, for example, terrain, runways, and political boundaries. It will be appreciated that the processor 404 may implement any one of numerous types of image rendering methods to process the data it receives from the terrain database 406, the navigation database 408, and/or the terminal procedure data source 424, to cause the display devices 426, 428 to render the views displayed therein.

In addition to the data, icons, and/or images delineated above, and as was previously mentioned, both the PFD 426 and the MFD 428 are also used to selectively display terminal procedure data for a corresponding terminal procedure. The terminal procedure data may include electronic versions of terminal procedure publication charts (e.g., DP charts and STAR charts) as well as departure procedure data and arrival procedure data extracted from the DP database 450 and STAR database 452, respectively. To further illustrate the selective display of terminal procedure data, a departure procedure and an arrival procedure are described below, beginning with the departure procedure.

Prior to an aircraft leaving a gate or tarmac, the flight crew identifies a desired departure procedure by selecting departure procedure parameters (e.g., a departure runway and departure transition) for the appropriate airport departure. This selection may take any one of numerous forms, and may be accomplished either graphically or textually. In a particular preferred embodiment, however, a selectable menu is displayed. FIG. 8 depicts an exemplary selectable menu 500 for use with embodiments of the present invention. Selectable menu 500 includes a list of runways 502 and departure transitions 504 for the Wagge Two Departure from the Reno-Tahoe International Airport. To select a particular procedure, the pilot 430 moves a cursor using the CCD 432 and selects the desired runway and departure transition. It will be appreciated that the selectable list may be displayed on either the PFD 426 (FIG. 6) or the MFD 428 (FIG. 7), but it is preferably displayed on the MFD 428. It will additionally be appreciated that the selectable list may be displayed in any one or more of the MFD display area sections 482, 484, 486.

Returning to FIG. 5, after pilot 430 selects the terminal procedure parameters for the appropriate airport departure, processor 404 selectively retrieves the corresponding departure procedure data from the terminal procedure data source 424. As described above, processor 404 may access the DP database 450 to retrieve the departure procedure data (e.g., departure procedure descriptions and notes) that are either associated with the appropriate airport arrival and the selected terminal procedure parameters or comprise general information that is relevant to every departure procedure for the appropriate airport arrival. Processor 404 then displays the retrieved departure procedure data on an appropriate display 426, 428.

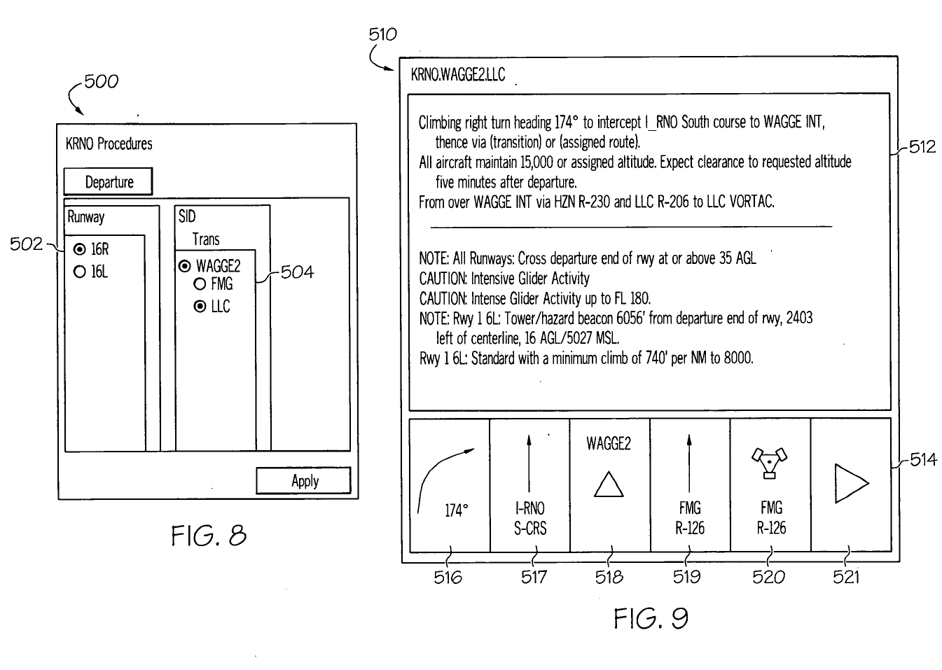

FIG. 9 depicts an exemplary user display window 510 for displaying the departure procedure data retrieved from the DP database 450 (FIG. 5). It will be appreciated that display window 510 may be displayed on either the PFD 426 or the MFD 428, but it is preferably displayed on the MFD 428. It will additionally be appreciated that menu 500 may be displayed in any one or more of the MFD display area sections 482, 484, 486. As depicted, the user display window comprises a text display area 512 and an iconic data display area 514. Text display area 512 displays departure procedure data that is selectively retrieved from the DP database 450 (FIG. 5). For example, with reference to FIGS. 2 and 9, rows 260, 262, 263, 265-266, 268-269, and 271 each include departure procedure data that corresponds to Runway 16L, the Livelock Transition, or all of the departure procedures for the Wagge Two Departure for the Reno-Tahoe International Airport. As depicted, the descriptive text within the departure procedure data field 252 for each of those rows is included in the text display area 512 of display window 510.

In one embodiment, processor 404 (FIG. 5) utilizes the data type field 258 of the DP database 250 to display all of the appropriate departure procedure descriptions in a first section of the text display area 512 and all of the appropriate departure procedure notes in a second section of the text display area 512. In addition, processor 404 may present the departure procedure descriptions and notes in the order in which they are most likely to be used by the flight crew. For example, generally the flight crew will want to see information regarding a departure runway before viewing information regarding a departure transition. Accordingly, processor 404 may utilize the data type field 258 to ensure that departure procedure descriptions that correspond to a departure runway are listed before the departure procedure descriptions for a departure transition. Similarly, processor 404 may list departure procedure notes corresponding to a runway before departure procedure notes that correspond to a departure transition.

The iconic data display area 514, displays one or more iconic representations of the departure procedure descriptions displayed in the text display area 512. Each icon 516, 517, 518, 519, 520 comprises symbols and text that describe one or more steps outlined by the departure procedure descriptions, displayed in the text display area 512. For example, if the departure procedure description instructs the flight crew to proceed at a certain course or heading, the corresponding icon may comprise an arrow describing the corresponding movement of the aircraft and the heading or course name. Further, if the departure procedure description identifies a specific marker or location (e.g., such as a VORTAC) the corresponding icon may comprise a symbol and name for the marker or location. A member of the flight crew may read the departure procedure descriptions prior to performing a departure procedure and then refer back to the iconic data display area 514 periodically to remind themselves of the appropriate steps for performing the desired departure procedure. In addition, a selectable scroll icon 521 is also depicted. When scroll icon 521 is selected (e.g., by the pilot 430 utilizing a cursor and CCD 432 of FIG. 5) processor 404 (FIG. 5) displays one or more additional icons describing subsequent steps. Icons 516-520 may be generated beforehand and associated with the corresponding departure procedure description or they may be generated by processor 404 when the corresponding departure procedure description is selectively retrieved from DP database 250.

As an aircraft approaches the top-of-descent (TOD) of the en route airspace, the flight crew prepares for landing at the destination. This preparation includes selection of an appropriate terminal procedure parameter (e.g., an arrival transition) for the desired arrival airport. This selection may take any one of numerous forms, and may be accomplished either graphically or textually. In a particular preferred embodiment, however, a selectable menu is displayed. For example, a selectable menu substantially similar to the selectable menu described above with regard to FIG. 8 and comprising a list of arrival transition for the appropriate airport arrival. In the description provided below, it will be assumed that the flight crew has selected the San Simon Transition for the Sunss Five Arrival for Sky Harbor International Airport.

Returning to FIG. 5, after the flight crew selects an arrival transition for the appropriate airport arrival, processor 404 selectively retrieves corresponding arrival procedure data from the terminal procedure data source 424. The retrieved arrival procedure data may include arrival procedure data (e.g., arrival procedure descriptions and notes) that is stored in the STAR database 452 and associated with the appropriate airport arrival (e.g., the Sunss Five Arrival) and the selected terminal procedure parameter (e.g., the San Simon Transition). Processor 404 then displays the retrieved departure procedure data on an appropriate display 426, 428.

For example, the arrival procedure data may be displayed in the user display window 510 of FIG. 9. With reference to FIGS. 4 and 9, rows 360, 362, 363, and 364 of STAR database 350 each include arrival procedure data that corresponds to the Sans Simon Transition, or to all of the arrival procedures, for the Sunss Five Arrival. In this case, the arrival procedure data from those rows would be retrieved and displayed in the text display area 512 of the user display window 5 10. In addition, processor 404 (FIG. 5) may display icons corresponding to one or more steps described by the arrival procedure descriptions in the iconic display area 514 of the user display window 510.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

We claim:

1. A flight deck display system for selectively displaying terminal procedure data, the flight deck display system comprising:
at least one display device;
a terminal procedure data source; and
a processor coupled to the at least one display device and the terminal procedure data source, the processor configured to:
selectively retrieve the terminal procedure data from the terminal procedure data source, wherein the terminal procedure data comprises descriptive text of the type displayed on a terminal procedure publication chart for a corresponding terminal procedure and associated with at least one selected terminal procedure parameters; and
display the retrieved terminal procedure data on the at least one display device.

2. The flight deck display system of claim 1, wherein the retrieved terminal procedure data further comprises descriptive text of the type displayed on a terminal procedure publication chart for the corresponding terminal procedure and comprising general information relevant to a plurality of terminal procedures described by the terminal procedure publication chart.

3. The flight deck display system of claim 2, wherein the terminal procedure data comprises a departure procedure description comprising one or more steps for performing a departure procedure.

4. The flight deck display system of claim 3, wherein the at least one selected terminal procedure parameter comprises a departure runway and a departure transition.

5. The flight deck display system of claim 3, wherein the processor is further configured to display an icon describing at least one of the steps described by the departure procedure description.

6. The flight deck display system of claim 3, wherein the terminal procedure data further comprises a departure procedure note providing additional information regarding the departure procedure.

7. The flight deck display system of claim 2, wherein the terminal procedure data comprises an arrival procedure description comprising one or more steps for performing an arrival procedure.

8. The flight deck display system of claim 7, wherein the at least one selected terminal procedure parameter comprises an arrival transition.

9. The flight deck display system of claim 7, wherein the processor is further configured to display an icon describing at least one of the steps described by the arrival procedure description.

10. The flight deck display system of claim 7, wherein the terminal procedure data further comprises an arrival procedure note providing additional information regarding the arrival procedure.

11. A computer readable medium comprising instructions that when executed by a processor cause the processor to perform a method comprising the following steps:
selectively retrieving terminal procedure data from a data source based on one or more selected terminal procedure parameters, wherein the retrieved terminal procedure data comprises descriptive text of the type displayed on a terminal procedure publication chart; and
displaying the retrieved terminal procedure data on a display device coupled to the processor.

12. The computer readable medium of claim 11, wherein:
the step of selectively retrieving further comprises selectively retrieving at least one departure procedure description based on a selected departure runway and departure transition, wherein the at least one departure procedure description comprises one or more steps for performing a departure procedure; and
the step of displaying further comprises displaying the at least one departure procedure description on the display device.

13. The computer readable medium of claim 12, wherein the step of displaying further comprises:
displaying one or more icons describing at least one of the steps for performing the departure procedure.

14. The computer readable medium of claim 11, wherein:
the step of selectively retrieving further comprises selectively retrieving at least one arrival procedure description based on an arrival transition, wherein the at least one arrival procedure description comprises a description of one or more steps for performing an arrival procedure; and
the step of displaying further comprises displaying the at least one arrival procedure description on the display device.

15. The computer readable medium of claim 14, wherein the step of displaying further comprises:
displaying one or more icons describing at least one of the steps described by the at least one arrival procedure description.

16. A flight deck display system for selectively displaying terminal procedure data, the flight deck display system comprising:
at least one display device;
a terminal procedure data source;
a processor coupled to the at least one display device and the terminal procedure data source, the processor configured to:
selectively retrieve terminal procedure data from the terminal procedure data source, wherein the retrieved terminal procedure data comprises:
descriptive text of the type displayed on a terminal procedure publication chart for corresponding terminal procedure and associated with one or more selected terminal procedure parameters; and
descriptive text of the type displayed on a terminal procedure publication chart for the corresponding terminal procedure and comprising general information relevant to a plurality of terminal procedures described by the terminal procedure publication chart; and.
display the retrieved terminal procedure data on the at least one display device.

17. The flight deck display system of claim 16, wherein:
the retrieved terminal procedure data comprises at least one departure procedure description comprising one or more steps for performing a departure procedure; and
the one or more selected terminal procedure parameters comprises a departure runway and a departure transition.

18. The flight deck display system of claim 17, wherein the processor is further configured to display at least one icon describing one or more steps for performing the departure procedure.

19. The flight deck display system of claim 16, wherein:
the retrieved terminal procedure data comprises at least one arrival procedure description comprising one or more steps for performing an arrival procedure; and
the one or more selected terminal procedure parameters comprises an arrival transition.

20. The flight deck display system of claim 19, wherein the processor is further configured to display at least one icon describing one or more steps for performing the arrival procedure.
